(19) United States
(12) Patent Application Publication
(10) Pub. No.: US 2021/0171777 A1
(43) Pub. Date: Jun. 10, 2021

(54) Systems And Methods For Pollutant Removal From Fluids With Pelletized High Strength Carbon Products With Reactive Binders

(71) Applicant: C12 Environmental Services, LLC, Gainesville, FL (US)

(72) Inventors: Regina Rodriguez, Gainesville, FL (US); David W. Mazyck, Gainesville, FL (US); Stephen Suau, Sarasota, FL (US)

(21) Appl. No.: 17/116,618

(22) Filed: Dec. 9, 2020

Related U.S. Application Data
(60) Provisional application No. 62/945,598, filed on Dec. 9, 2019.

(51) Int. Cl. C09C 1/58; C01F 5/02; C01F 7/02; C02F 1/28

(52) U.S. Cl. CPC C09C 1/58; C01F 5/02; C02F 2101/163; C02F 1/281; C01F 7/025

(57) ABSTRACT

A sorbent composition for pelletized carbon products having high strength and water resistance is disclosed. The invention also includes a method of producing sorbent compositions of pelletized carbon products having high adsorption capacities of phosphate and nitrates including the use of a metal oxide as a binder. The invention further includes a system for removing nutrients from a pollutant stream.

### CROSS REFERENCE TO RELATED APPLICATIONS

This application claims the benefit of and priority to U.S. Provisional Patent Application Ser. No. 62/945,598, filed Dec. 9, 2019. The entire specification and figures of the above-referenced application are hereby incorporated in their entirety by reference herein.

### FIELD OF THE INVENTION

This invention relates to sorbent compositions of pelletized biochar or pelletized carbonaceous products including a reactive binder, and, more particularly, to methods of producing pelletized carbon products with a reactive binder having high mechanical strength, uniform size, and a high capacity for the removal of pollutants from fluid streams.

### BACKGROUND OF THE INVENTION

Without limiting the scope of the present invention, its background will be described in relation to methods and compositions of pelletized carbon products and its application for the removal of nutrients and catalysis of contaminants from liquid streams.

Binders are required to manufacture extruded materials that have high mechanical strength and do not easily fracture. Typically, these binders are benign whereby they achieve mechanical stability, but do not contribute to the performance of the extruded material for the given application. For example, bentonite, methyl cellulose, and coal tar pitch are common binders for the production of activated carbon pellets. However, these binders do not contribute to the performance of the activated carbon pellet for the intended application.

Mixed oxides can have reactive and catalytic properties for a myriad of applications including antibacterial applications, conversion of chemicals to benign substances through redox reactions, and absorption of pollutants from liquids and gases. The consistency of these mixed oxides are typically solids having a primary particle size greater than 1 um. To achieve the environmental and/or health benefits from this class of compounds, they are typically coated onto substrates. Alternatively, one could start with the oxides salt (e.g., MgCl2), add it to the sorbent through a wet chemical technique, and then subsequently expose the sorbent and salt to a high temperature to form a sorbent with a mixed oxide.

Disclosed here are methods to achieve high mechanical strength by using mixed oxides that have good properties for pollutant removal, catalysis, and/or anti-bacterial applications that can also serve as binders. Herein, these mixed oxide binders that serve both roles are termed “reactive binders”.

An area where reactive binders are novel include, but not limited to, is nutrient removal. Harmful algal blooms (HABs) present unique and potentially harmful challenges world-wide. At the very least, HABs negatively impact the aesthetic quality of water from blue-green algae or red-tides. Eventually, these reoccurring HABs can result in “dead” water bodies as the algae consumes oxygen during its decay leading to insufficient oxygen to support fish and other aquatic life. Therefore, there is a significant negative economic impact from HABs.

The number one cause of HABs is from excess nutrients, namely nitrate and phosphorous, that are often released from fertilization practices and can accelerate eutrophication in surface waters. The nutrients can be transported to lakes, reservoirs, and oceans from storm water and land runoff water. Furthermore, there is a growing body of evidence that extended exposure can result in neurologic impacts to mammals; these negative impacts are being further researched. Similarly, nutrients in wastewater including nitrate and phosphorous are prevalent in water processed by wastewater treatment plants. Further yet, parts of the world such as Florida have high concentrations of phosphorous embedded within their soil system.

While biological systems are effective treatment technologies for wastewater treatment plants, they often do not meet stringent nitrate effluent goals. Furthermore, biological treatment systems are expensive, cumbersome to operate, and are inconsistent in their operation. Presently, there are limited if any solutions to remediate legacy systems, such as the Everglades, or to treat storm water and/or run off water. These waters need an engineering solution that can be easily implemented, performs consistently, and is feasible.

Biochar results from the pyrolysis of biomass materials, e.g., pine, bagasse, sugar beet tailings, and any other biomass material that is often a waste product, particularly from forest products or agricultural practices. These biomass materials are pyrolyzed at temperatures typically greater than 350 deg. C to form a char, namely, biochar. The resulting material has a low volatile content, moderate surface areas (e.g., 100 to 500 m²/g), and a basic surface charge. Overall, biomass materials such as biochar are low-cost sorbents.

The state of Florida is actively managing the safety of Floridians through constant monitoring of waterways for algal bloom sites, testing to determine algal ID, and determining whether microcystin toxins are detected. In portions of southwest Florida, the Florida Department of Environmental Protection requires that wastewater discharged to surface waters meet Advanced Wastewater Treatment (AWT) standards which limits average annual nutrient concentrations to 3 mg/L of total nitrogen and 1 mg/L of total phosphorous (FDEP, 2013).

However, biochar is typically not capable of achieving nutrient treatment goals of 1 mg/L of total phosphorous and 3 mg/L of total nitrogen. The primary adsorption mechanism of biochar is electrostatic attraction because the biochar surface is typically positively charged. Van der Walls adsorption and cation exchange are also possible absorption mechanisms. Further confounding the removal of nitrate and phosphorous is the fact that many other anions are present in solution thus creating competition for the same sites.

One known study tested thirteen biochar samples which comprised various raw sources and pyrolyzed the samples at temperatures ranging from 300-600° C. to remove ammonium, nitrate, and phosphate. Of the samples tested, the highest removal rates ranged from 0.12-15.7% with most showing little or no nitrate or phosphate removal ability. Similarly, results from studies by the inventors of the present invention showed very little removal of nitrate and phosphate when six different biochar samples produced from varied raw materials were tested.

Biochars are known to be used for nutrient adsorption, particularly when impregnated with salts (e.g., MgCl₂). One known test impregnated carbonaceous raw materials like sugar beet tailings, sugarcane bagasse, cottonwoods, pinewoods, and peanut shells were impregnated with MgCl₂ pre-pyrolysis to compare the competitive adsorption between phosphates and nitrates for each material. FIG. 1 is a graph illustrates removal of nutrients by MgO-biochar. By treating (impregnating) the biochar with a positively charged metal (e.g., Al³⁺ or Mg²⁺), a complex (e.g., magnesium phosphate) can be produced upon contact with nutrients.

Another known test impregnated carbonaceous materials with AlCl₃ including pyrolysis to form the metal oxide and observed the competitive adsorption of nitrates, phosphates, sulfates, and chlorides. The results demonstrated high phosphate removal percentages ranging from 68-90% at 0.1 and 0.2 M chemical concentrations, pH solutions of 6.0 and 9.0, and a variety of biochars. Phosphate removal increased with an increase in pH solution and changed depending on the solution concentration and type of biochar used. Impregnation with AlCl₃ promoted high phosphate (68-90%) removal rates with lower competitive adsorption occurring since nitrate removal ranged between 20-40%.

The solution to improving biochar's efficacy is through the impregnation with compounds that can enhance nutrient uptake once converted from their salt form to an oxide. Here, there are two means to create this “enhanced” biochar. In one method, a biochar is impregnated with a metallic salt, and then heated to above, about 350 deg. C, to convert the salt to an oxide. This approach is not feasible as significant cost is added by impregnating the biochar with the salt and then heating the impregnated biochar to high temperatures (e.g., 650 deg. C). When biochars or other carbon sorbents are impregnated with salts (e.g., MgCl₂), the MgCl₂ forms MgO (a mixed oxide) upon further heating and enhances phosphate removal through chemical adsorption. Drawbacks to this application include the additional energy requirement to convert the salt to an oxide, and while it is conceivable that phosphate concentrations could be lowered to less than 1 mg/L, nitrate removal is much less promising.

Furthermore, these salts are corrosive and require exotic metals and/or refractory linings to prevent pyrolysis equipment damage. An alternative method is to impregnate the raw biomass with the metal salt, and then pyrolyze this impregnated material. However, the raw biomass has essentially no surface area. Therefore, very little salt is incorporated within the biomass matrix. If this approach is pursued, the salts are corrosive to pyrolysis equipment. Hence, this is why these materials are not commercially available.

### SUMMARY OF THE INVENTION

In some embodiments of the invention, it is directed to methods and compositions of pelletized carbon products with a reactive binder having high uptake of pollutants from fluids (e.g., phosphate(s) and nitrate(s)).

Extrusion provides a unique solution to overcome all of the limitations discussed previously whereby a carbonaceous (e.g., biochar) pellet is engineered so that the binder is reactive (e.g., high absorption capacity for nitrate and phosphate) and the extrusion also results in a pellet with high mechanical strength. A pelletized carbon product of the invention is made in an extrusion process that requires the carbonaceous sorbent, a reactive binder, and a machine (extruder) to produce the pellet.

A die opening diameter of the extruder die can be selected to produce pellets that range in size, for example, from 2 to 10 mm in diameter and similar lengths by simply changing the cutter speed. The pellet shape and length for carbon products of the invention are determined by the intended application for use; accordingly, the ranges discussed herein are not intended to limit the scope of the invention.

MgO can serve as a reactive binder, and therefore, not only forms a resilient pellet (very high hardness), but also a key additive to enhance nutrient uptake (e.g., magnesium oxide plus nitrate yields magnesium nitrate). The process for making the pelletized carbon products of the invention is simple, feasible, and other additives can be included to enhance nutrient uptake, control pH, and target other pollutants. Extrusion into pellets allows for the already effectively tailorable biochar material to be incorporated and mixed into a countless number of possible formulations, shapes, and chemical/ adsorptive characteristics.

In one particular embodiment, the present invention is directed at a pelletized carbon composition comprised of powdered or granular biochar or carbonaceous material and at least one binder, whereby the binder (e.g., MgO) can form a bond (i.e., the binder is reactive) with phosphate, nitrate, or both. In this embodiment, the metal oxide serves to not only bind and hold together the biochar to produce an extruded pellet but can also form a complex with nutrients. The sorbent to mixed oxide ratio can be as high as 100:1 and as low as 1:100, preferably lower than 10:1 and more preferably lower than 2:1.

In another embodiment, the present invention includes two metal binders to enhance nutrient removal. These binders could include, for example, MgO and AlO whereby at least one of the binders serves two purposes: binding and complexation of nutrients. The two-binder system serves to address competitive adsorption phenomena because most waters will have several inorganic compounds competing for adsorption sites. One skilled in the art would recognize that additional metal oxides could be added to further improve nutrient removal. The sorbent to mixed oxide ratio can be as high as 100:1 and as low as 1:100, preferably lower than 10:1 and more preferably lower than 2:1.

Considering the above-described features of the invention, in one aspect, the invention may also be considered a pelletized carbon composition, comprising: a carbonaceous material; a metal oxide; and wherein the metal oxide is a reactive binder yielding high mechanical strength for said composition.

According to another aspect of the invention, it may be considered a method of making pelletized carbon compositions comprising mixing a powdered or granular carbonaceous sorbent, a metal oxide and water; extruding the mixture into pelletized structures; and drying the pelletized structures to form pelletized carbon compositions.

According to another aspect of the invention, it may be considered a method of producing pelletized carbon products comprising: providing a composition of carbonaceous material and a metal oxide; providing an extrusion device with a selected die size and cutter speed; feeding the composition through the die of the extrusion device with enough water to plasticize the mixture and to create pellets of a desired diameter and length; and wherein the metal oxide is a reactive binder yielding high mechanical strength for said composition.

According to yet another aspect of the invention, it may be considered a system for removing nutrients from a pollutant stream, said nutrients at least including nitrates or phosphorous, the system comprising: a waste fluid stream containing pollutants; a reactor unit that receives a quantity of a pelletized carbon composition, the pelletized composition comprising a carbonaceous material, a metal oxide, wherein the metal oxide is a reactive binder yielding high mechanical strength for said composition; and wherein the waste fluid stream flows through said reactor unit in which adequate contact is made between the waste fluid stream and the pelletized carbon composition for removing the nutrients.

According to any or all of the above described composition, methods, and system, further features of the invention may include wherein: said carbonaceous material includes powdered or granular biochar; said metal oxide includes MgO; said metal oxide is reactive with pollutants including at least one of phosphate and nitrate; a sorbent to mixed metal oxide ratio is between about 100:1 to 1:00, preferably lower than 10:1 and more preferably lower than 2:1; said metal oxide includes two metal binders; at least one of said two metal binders functions for binding and complexation of nutrients; and pellets of said pelletized carbon composition are dried to below 2% moisture and said pellets have a Ball Pan Hardness (BPH) of Activated Carbon above 95% and water resistance (i.e. mechanical integrity maintained when submerged in fluids); wherein pellets of said pelletized carbon composition maintain their mechanical strength even when submerged in a fluid for pollutant removal applications; wherein pellets of said pelletized carbon compositions attain the required mechanical strength (BPH) without requiring high temperature treatment or specialty chemicals; and wherein at least one of said two metal binders functions for binding and complexation of nutrients; and wherein said system may further include a filtration unit located downstream of the reactor unit to receive fluid of the waste fluid stream that was treated within the reactor unit.

### BRIEF DESCRIPTION OF THE DRAWINGS

FIG. 1 is a graph illustrating removal of nutrients by MgO-biochar;

FIG. 2 is graph illustrating pollutant removal according to the invention with respect to influent & effluent concentrations of total phosphorous in the presence of a pelletized biochar with a 2.3:1 sorbent to mixed oxide ratio; and

FIG. 3 is a simplified schematic diagram depicting a system of the invention for controlling pollutants from a waste or pollutant stream.

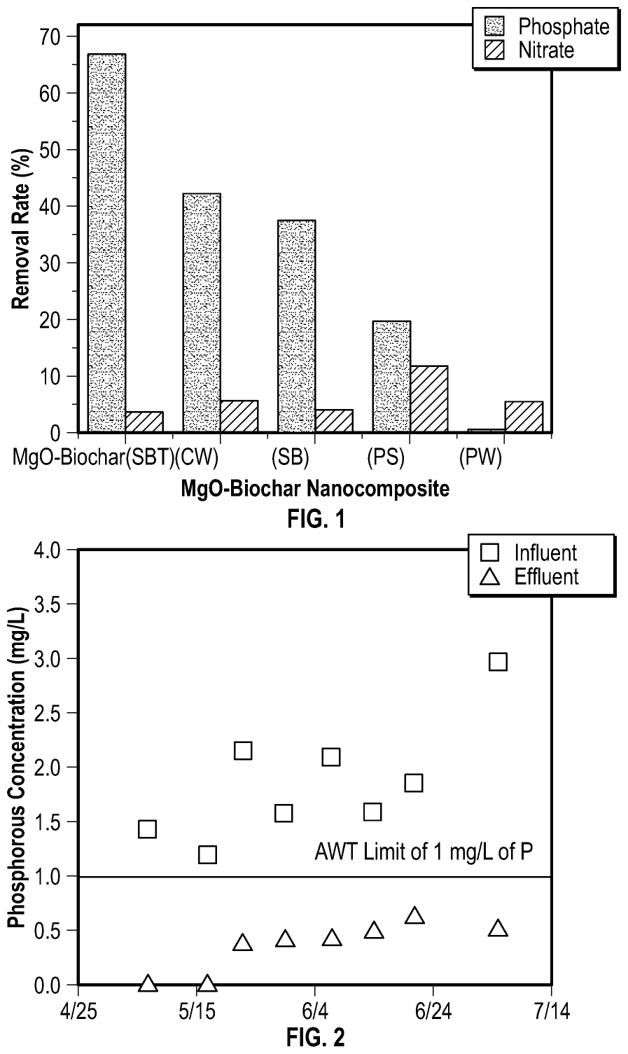

### DETAILED DESCRIPTION OF THE INVENTION

Embodiments of the present invention are distinguishable over the conventional prior art because the prior art focuses on the use of metal salts and subsequent conversion through high temperature heating to form metal oxides as active components of carbon products. The prior art does not disclose use of metal oxides that function to bind activated carbon particles together.

In connection with embodiments of the present invention, metal oxides can be used as binders to produce pelletized carbon products with high mechanical strength and water resistance properties. The use of these metal binders has multiple functions in the pelletized carbon products. Firstly, they serve as the primary binder system to maintain the structure and shape of the pelletized carbon products. Secondly, they serve as a catalyst/active component of the pelletized carbon products for pollutant removal from fluids. In this respect, the dual function of metal oxides in pelletized carbon products has not been explored in the prior art.

Further in connection with embodiments of the present invention, water resistant and high strength carbon products can be made with manufacturing methods that do not require high temperature treatments or complex chemical processes. Furthermore, in embodiments of the present invention, it was revealed that pelletized carbon products made with metal oxide binders can be used for high temperature applications while still maintaining their high mechanical strength and water resistance.

According to the invention in the examples that follow, pelletized carbon products cylindrical in shape with 4 mm diameter and 4 mm length were extruded with a full-scale extruder. Dry components were mixed together with sufficient water to plasticize the mixture as it was fed through the extruder. Extruded pellets were dried to below 2% moisture at 150° C. Pellet hardness of the finished pelletized carbon composition was determined using the ASTM D3802 for Ball Pan Hardness (BPH) of Activated Carbon to be above 95%.

### EXAMPLE 1

Pelletized carbon products were produced per the material compositions in Table 1. The binder composition of the present invention (2:1 up to 8:1 sorbent (SB) to Metal oxide (XO) ratio) shows that sufficient mechanical hardness can be attained using a metal oxide as a binder and without requiring high temperature treatment or specialty chemicals.

In this example the sorbent was dry and powdered biochar and the metal oxide was 93% purity magnesium oxide in its powdered form.

TABLE 1
Pilot scale production of pelletized biochar
and magnesium oxide (single binder)

| Ratio of | Ball Pan Hardness | Density | Particle Size |
|---|---|---|---|
| SB:XO | (%) | (g/mL) | (Diameter) |
| 2.0 | 99 | 0.62 | 4 mm |
| 3.6 | 98 | 0.61 | 4 mm |
| 8.1 | 99 | 0.58 | 4 mm |
| 2.3 | 88 | 0.55 | 4 mm |
| 2.6 | 87 | 0.59 | 4 mm |
| 1.0 | 95 | 0.65 | 4 mm |
| 4.2 | 82 | 0.61 | 4 mm |
| 2.6 | 93 | 0.63 | 4 mm |
| 2.6 | 85 | 0.47 | 2 mm |
| 0.6 | 97 | 0.67 | 4 mm |
| 2.6 | 90 | 0.61 | 4 mm |

### EXAMPLE 2

In the example that follows, the extruded pelletized carbon was produced per the material compositions in Table 2. Sufficient surface area remains on the pellet to allow for sorption and constituent diffusion into the pellet. In addition, phosphorous removal of the resulting materials decreased with higher carbon content or lower metal oxide content thus showing the reactivity of the reactive binder for pollutant removal from fluids

TABLE 2
Lab Scale analysis for varying ratios of sorbent to metal oxide

| | | Average | Total | Phosphorous |
|---|---|---|---|---|
| | Surface | Pore | Pore | Capacity |
| Ratio of | Area | Size | Volume | (mg P/ |
| SB:XO | (m²/g) | (Å) | (cc/g) | g Pellet) |
| 2.0 | 225 | 34.00 | 0.19 | 0.96 |
| 3.6 | 235 | 34.00 | 0.2 | 0.83 |
| 8.1 | 255 | 30.00 | 0.19 | 0.45 |
| 2.3 | — | — | — | 0.82 |
| 2.6 | — | — | — | 1.83 |
| 1.0 | — | — | — | 3.06 |
| 4.2 | — | — | — | 1.22 |
| 2.6 | — | — | — | 1.09 |
| 1:0 | — | — | — | 0.13 |

### EXAMPLE 3

In the examples that follows, the extruded pelletized carbon was produced per the material compositions in Table 3.

TABLE 3
Lab Scale analysis for varying purity of metal oxide

| | | | | Phosphorous |
|---|---|---|---|---|
| | XO | Surface | Ball Pan | Capacity |
| Ratio of | Purity | Area | Hardness | (mg P/g |
| SB:XO | (%) | (m²/g) | (%) | Pellet) |
| 2.0 | 93 | 235 | 99 | 0.96 |
| 2.0 | 60 | 216 | 99 | 0.30 |

In this example, the sorbent was dry and powdered biochar and the metal oxide was magnesium oxide in its powdered form with variation in purity from 93% to 60%. The lower purity magnesium oxide had a remaining composition of other metal oxides including Fe₂O₃, Al₂O₃, CaO.

The pellet retained sufficient surface area of 235 and 216 m2/g respectively and similar ball pan hardness of 99%.

The phosphorous removal, however, decreased by a factor of 3 from 0.96 mg P/g of pellet to 0.30 mg P/g of pellet.

### EXAMPLE 4

In the example that follows, the extruded pelletized carbon was produced per the material compositions in Table 4 and exposed to phosphorous concentrations at a pilot program.

TABLE 4
Lab Scale analysis for pellet tested in the pilot program

| | | Average | Total | Phosphorous |
|---|---|---|---|---|
| | Surface | Pore | Pore | Capacity |
| Ratio of | Area | Size | Volume | (mg P/g |
| SB:XO | (m²/g) | (Å) | (cc/g) | Pellet) |
| 2.3 | 225 | 34 | 0.19 | 0.82 |

The pilot system was designed to treat reclaimed water at a rate of 0.3 gallons of water per square foot or equivalent to a desired maximum 6-hour contact time. The media depth tested in the reactor was 17 inches.

In this example the sorbent was dry and powdered biochar and the metal oxide was 93% purity magnesium oxide in its powdered form.

FIG. 2 illustrates pollutant removal according to the invention with respect to influent & effluent concentrations of total phosphorous in the presence of a pelletized biochar with a 2.3:1 sorbent to mixed oxide ratio.

The total phosphorous removal achieved was 79% to 89% and consistently below Advanced Wastewater Treatment (AWT) standards of 1 mg/L of total phosphorous.

### EXAMPLE 5

In the examples that follows, the extruded pelletized carbon was produced per the material compositions in Table 5.

TABLE 5
Lab Scale analysis for pellets produced
with powdered versus granular sorbent

| | | Surface | | Ball Pan |
|---|---|---|---|---|
| Ratio of | | Area | Density | Hardness |
| SB:XO | Sorbent Type | (m²/g) | (g/mL) | (%) |
| 2.0 | Dry - Powdered | 216 | 0.65 | 99 |
| 2.0 | Wet -Granular | 108 | 0.46 | 96 |
| | (60% Moisture Content) | | | |

In this example the sorbent was wet granular biochar and the metal oxide was magnesium oxide with a purity of 60%.

The pellet surface area resulted in 216 m²/g for the dry raw material and 108 m²/g for the wet raw material. This makes sense because the wet raw material has about 60% water content and therefore only 40% of the material has active surface area.

### EXAMPLE 6

In the examples that follow the extruded pelletized carbon products were produced for a multi-binder system per the material compositions in Table 6. The binder composition of the present invention (2.2:1 sorbent (SB) to metal oxide one (XO₁); 5.5:1 SB to metal oxide 2 (XO₂); and a total SB:XO ratio of 1.6:1) shows that sufficient mechanical hardness can be attained using multiple metal oxides as a binder and without requiring high temperature treatment or specialty chemicals.

In this example the sorbent was dry and powdered biochar and the metal oxides were: XO1-93% purity magnesium oxide in its powdered form and XO₂—iron (III) oxide, and iron oxide hydroxide, respectively.

TABLE 6
Pilot scale production of pelletized biochar
and magnesium oxide (multiple binders)

| | | | | | Phosphorous |
|---|---|---|---|---|---|
| | | | | Ball Pan | Capacity |
| Ratio of | Ratio of | Ratio of | Density | Hardness | (mg P/ |
| SB:XO₁ | SB:XO₂ | SB:XO_{TOTAL} | (g/mL) | (%) | g Pellet) |
| 2.2 | 5.5 | 1.6 | 0.64 | 94 | 1.27 |
| 2.2 | 5.5 | 1.6 | 0.63 | 97 | 1.43 |

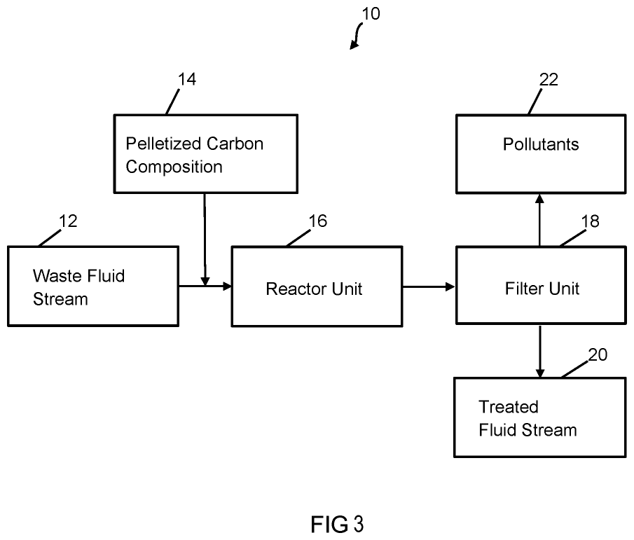

Referring now to FIG. 3, a simplified system 10 is illustrated for controlling pollutants from a waste fluid stream. This figure is intended to represent a simplified system, it being understood that additional processing may be added to this system in order to effectively treat a waste fluid stream. A waste fluid stream 12 enters a reactor unit 16 that is used to treat the fluid stream. At some point upstream of the reactor unit 16, the pelletized carbon composition 14 of the invention is introduced into the waste fluid stream 12.

It should be understood that depending upon the specific design of the reactor unit 16, the carbon composition can be added at concentrations or amounts appropriate to treat the contamination in the fluid stream. Therefore, greater or lesser amounts of the pelletized carbon can be used for optimal treatment within a particular reactor unit.

The specific manner in which the carbon composition is added to the waste stream may include any suitable means in which the carbon composition is adequately exposed to the waste fluid stream for absorption of contaminants. For example, the carbon composition may be added by exposing that composition through a torturous path of the waste stream, direct mixing, or combinations thereof.

The reactor unit itself may achieve adequate contact with the carbon composition of the invention by any one of selected modifications of the fluid stream flow such as providing adequate fluid turbulence, torturous path flow of the fluid under pressure, mechanical or vibratory mixing of the fluid stream, and others. The specific parameters for mixing and exposure times within the reactor can be determined based upon the particular chemical characteristics of the waste stream.

After treatment of the waste fluid stream 12 within the reactor 16, the waste fluid stream may be further treated, such as by a downstream filtration unit 18 in which a final separation is achieved between a treated fluid stream 20 and captured pollutants 22. The downstream filtering shall be understood to be an optional treatment step.

What is claimed is:

1. A pelletized carbon composition, comprising:
a carbonaceous material;
a metal oxide; and
wherein the metal oxide is a reactive binder yielding high mechanical strength for said composition.

2. The pelletized carbon composition, according to claim 1, wherein:
the metal oxide includes MgO.

3. The pelletized carbon composition, as claimed in claim 1, wherein:
said carbonaceous material includes powdered or granular biochar.

4. The composition, as claimed in claim 1, wherein:
said metal oxide is reactive with pollutants including at least one of phosphate and nitrate.

5. The pelletized carbon composition, as claimed in claim 1, wherein:
a sorbent to mixed metal oxide ratio is between about 100:1 to 1:00, preferably lower than 10:1 and more preferably lower than 2:1.

6. The pelletized carbon composition, according to claim 1, wherein:
a ratio of the carbonaceous material to the metal oxide is between 100:1 to 1:100.

7. The pelletized carbon composition, as claimed in claim 1, wherein:
said metal oxide includes two metal binders.

8. The pelletized carbon composition, as claimed in claim 8, wherein:
at least one of said two metal binders function for binding and complexation of nutrients.

9. The pelletized carbon composition, as claimed in claim 1, wherein:
pellets of said pelletized carbon composition are dried to below 2% moisture and said pellets have a Ball Pan Hardness (BPH) of activated carbon above 95%.

10. The pelletized carbon composition, as claimed in claim 9, wherein:
pellets of said pelletized carbon composition maintain their mechanical strength even when submerged in a fluid for pollutant removal applications.

11. The pelletized carbon composition, as claimed in claim 9, wherein:
pellets of said pelletized carbon compositions attain the required mechanical strength (BPH) without requiring high temperature treatment or specialty chemicals.

12. The pelletized carbon composition, as claimed in claim 1, wherein:
the metal oxide is a reactive binder capable of pollutant removal from fluids without requiring high temperature treatment to attain reactivity.

13. The pelletized carbon composition, according to claim 6, wherein:
the ratio is less than 10:1.

14. The pelletized carbon composition, according to claim 6, wherein:
the ratio is less than 2:1.

15. The pelletized composition, according to claim 1, wherein:
pellets of said pelletized carbon composition maintain their mechanical strength when submerged in a fluid for pollutant removal applications.

16. A method of making pelletized carbon compositions comprising:
mixing a powdered or granular carbonaceous sorbent, a metal oxide and water;
extruding the mixture into pelletized structures; and
drying the pelletized structures to form pelletized carbon compositions.

17. The method of claim 16, wherein:
sufficient water is added to plasticize the mixture.

18. The method of claim 16, wherein:
the water is a solution of water with pH modifier.

19. The method, according to claim 16, wherein:
the metal oxide includes MgO.

20. The method, according to claim 16, wherein:
the metal oxide includes MgO and AlO.

21. The method, according to claim 16, wherein:
a ratio of the carbonaceous sorbent to the metal oxide is between 100:1 to 1:100.

22. The method, according to claim 21, wherein:
the ratio is less than 10:1.

23. The method, according to claim 21, wherein:
the ratio is less than 2:1.

24. A method of producing pelletized carbon products comprising:
providing a composition of carbonaceous material and a metal oxide;
providing an extrusion device with a selected die size and cutter speed;
adding sufficient water to plasticize the mixture;
feeding the composition through the die of the extrusion device to create pellets of a desired diameter and length; and
wherein the metal oxide is a reactive binder yielding high mechanical strength for said composition.

25. The method, according to claim 24, wherein:
said carbonaceous material includes powdered or granular biochar.

26. The method, according to claim 24, wherein:
said metal oxide includes MgO.

27. The method, according to claim 24, wherein:
said metal oxide is reactive with pollutants including at least one of phosphate and nitrate.

28. The method, according to claim 24, wherein:
a sorbent to mixed metal oxide ratio is between about 100:1 to 1:00, preferably lower than 10:1 and more preferably lower than 2:1.

29. The method, according to claim 24, wherein:
said metal oxide includes two metal binders.

30. The method, according to claim 29, wherein:
at least one of said two metal binders functions for binding and complexation of nutrients.

31. The method, according to claim 24, wherein:
pellets of said pelletized carbon composition are dried to below 2% moisture and said pellets have a Ball Pan Hardness (BPH) of Activated Carbon above 95%.

32. A system for removing nutrients from a pollutant stream, said nutrients at least including nitrates or phosphorous, the system comprising:
a waste fluid stream containing pollutants;
a reactor unit that receives a quantity of a pelletized carbon composition, the pelletized composition comprising a carbonaceous material, a metal oxide, wherein the metal oxide is a reactive binder yielding high mechanical strength for said composition; and
wherein the waste fluid stream flows through said reactor unit in which adequate contact is made between the waste fluid stream and the pelletized carbon composition for removing the nutrients.

33. The system, according to claim 32, further comprising:
a filtration unit located downstream of said reactor unit to receive fluid of the waste fluid stream that was treated within the reactor unit.
